(19) United States
(12) Patent Application Publication
(10) Pub. No.: US 2004/0061976 A1
(43) Pub. Date: Apr. 1, 2004

(54) Thin-film magnetic head, method for producing the same and magnetic disk device having a slider using the same

(76) Inventor: Masatoshi Nakayama, Tokyo (JP)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/617,532

(22) Filed: Jul. 11, 2003

(30) Foreign Application Priority Data
Jul. 11, 2002 (JP) 2002-202368

(51) Int. Cl. G11B 5/39; G11B 5/255

(52) U.S. Cl. 360/313; 360/122

(57) ABSTRACT

An, magnetoresistive thin-film magnetic head with high corrosion resistance for recording medium having massive capacity is provided by providing a protective film having a thickness of 40 Å or less. Since the distance between the head and the medium is remarkably reduced, the film is suitable for a recording medium having high-packing density. The magnetoresistive type thin-film magnetic head is provided, wherein a protective film made of a diamond-like thin film having the composition represented by the following formula: CHₐO_{b}N_{c}F_{d}BₑP_{f} (where a=0-0.7, b=0-1, c=0-1, d=0-1, e=0-1 and f=0-1, in terms of atomic ratio), and having a thickness of 40 Å or less, is formed on at least the surface of the head contacting a recording medium. Also provided are a method for producing the same, and a magnetic head device using the same.

### BACKGROUND OF THE INVENTION

The present invention relates to a thin-film magnetic head, a method for producing the same and a magnetic disk device having a slider using the same, and particularly, to a thin-film magnetic head using a magnetoresistive film, for example, of MR Magnetoresistive) type, GMR (Grand Magnetoresistive) type, IMP (Tunneling Junction Magnetoresistive) type, and CCP (Current Perpendicular in Plane) type, and a method for producing the same, and a magnetic disk device having slider using the same.

### PRIOR ART

In the field of magnetic recording, demands for higher density have been increased and development has been made to meet such demands. As the higher density has been attained, several types of head for hard disk have been studied and developed, such as a thin-film magnetic head in which a soft magnetic thin film is used as a magnetic pole, and an MR head in which recording is performed by an induction type head and reproduction is conducted utilizing magnetoresistance effect.

An MR head is a device that reads an external magnetic signal by utilizing the change in resistance at the reading sensor portion using a magnetic material. In the case of the MR head, reproduction output relies on the magnetic signal of the recording medium but not on the relative velocity to the recording medium. Therefore, higher output can be obtained even in the case of the magnetic recording of high linear packing density. In the case of the MR head, a magnetoresistive film MR film) is generally sandwiched by a pair of magnetic shield films, which is called shield type MR head, in order to increase resolving power and to obtain excellent radio-frequency properties. In this case, the MR head is just a reproduction head, and therefore, an MR induction type combined head, in which an induction type head portion for recording is integrated with the MR head portion, is used.

Typically, with respect to the thin-film magnetic head, CSS (Contact Start Stop) type is adopted in which the thin-film magnetic head is floated above the recording medium by bearing effect of air. The head is generally held at a minute distance (about 0.2-2.0 μm) above the magnetic disc rotating at a high speed. Therefore, surface strength and abrasion resistance, which provide tolerance to head crash and CSS abrasion, are important. Various studies have been made to improve abrasion resistance, such as one disclosed in Japanese Patent Application Kokai No. 4-276,367, in which a protective film is formed on a rail of a magnetic head slider. This protective film consists of a silicone adhesive layer and a hydrogen-containing amorphous carbon film, having the overall thickness of 250 Å or less. However, the film exhibits poor strength since silicon is used in the adhesive layer. In addition, when such a silicon adhesive layer is applied to the magnetic thin-film magnetic head structure consisting of a sintered substrate made of alumina and titanium carbide, an alumina insulation layer, a thin film made of soft magnetic material (e.g. permalloy, Sendust, iron nitride and the like) and the like, cohesion or adhesiveness between the thin-film magnetic head and the protective film becomes poor, leading to problems such as peeling of the film and insufficient abrasion resistance.

Japanese Patent No. 2,571,957 discloses that a buffer layer consisting of amorphous silicon and amorphous silicon carbide is formed on the surface of an oxide, and then a film of carbon or film mainly composed of carbon is further formed thereon. However, even though the protective layer with the buffer layer is applied to the thin-film magnetic head, sufficient durability cannot be attained. In addition, it has disadvantages in that the extra step is required to form the buffer layer other than the step to form the protective film, leading to longer production period and higher production cost. Moreover, the buffer layer makes the film thicker, which opposes the demands on the magnetic head for hard disk such as cost-effectiveness, mass-productivity and larger packing density.

In the general method for forming a silicon interlayer used in industry, silicon atoms are just sputtered and chemical bonds are not formed between silicone atoms. The resultant layer has low hardness and poor denseness, leading to the formation of masses of silicon atoms. Therefore, when the protective film is made thinner, sufficient corrosion resistance and abrasion resistance (CSS) cannot be attained. In other words, when a thin diamond-like carbon film is formed on the surface of the silicon buffer layer by sputtering method, chemical bonds are not formed between silicon atoms, resulting in poor denseness of the silicon interlayer and formation of fine masses, and the diamond-like carbon film merely covers the silicon interlayer. Therefore, when the diamond-like carbon film is formed thinner, corrosive gases such as moisture easily penetrate through the silicon interlayer and then corrode the layer, and also the diamond-like protective film may peel off In addition, there arises another problem that the metal on the side of the thin-film magnetic head is corroded and dispersed in the silicon, which changes the electric resistance, which in turn degrades the properties of the thin-film magnetic head.

On the other hand, the present inventors proposed in Japanese Patent Application Kokai Nos. 10-289419 and 10-275308 a protective film for thin-film magnetic head, exhibiting strong cohesion to the components of the thin-film magnetic head, excellent corrosion resistance and excellent abrasion resistance. Specifically, for example in Japanese Patent Application Kokai No. 10-275308, a thin-film magnetic head exhibiting excellent durability is provided which has a protective film represented by the formula: SiC_{X}H_{Y}O_{Z}N_{W} (each of X, Y, Z and W is represented in terms of atomic ratio, where X=3-26, Y=0.5-13, Z=0.5-6 and W=0-6).

### THE PROBLEM TO BE SOLVED BY THE INVENTION

Today, a recording medium having a massive capacity, such as a disc having a capacity of up to 80 Gpsi, is widely used. In the case of magnetic recording with such a massive capacity, it is necessary to reduce the distance between the head and the recording medium in order to obtain high packing density. However, when a thick protective film is present on the head, more distance is provided due to this thickness, and thus such a film is not suitable for higher density media.

The protective film disclosed in the above-mentioned Japanese Patent Application Kokai No. 10-275308 has a thickness of approximately 70 Å. When the thickness is above this value, sufficient corrosion resistance and abrasion resistance can be obtained. On the other hand, in order to attain higher density, the protective film should be formed as thin as possible, so as to reduce the distance. However, when the thickness is below the value, sufficient corrosion resistance cannot be obtained (the reason is believed that it contains Si), and it is not appropriate to make the protective film thinner.

### SUMMARY OF THE INVENTION

The present inventor has made intensive and extensive studies by focusing on the fact that, in the case of conventional magnetoresistive type thin-film magnetic head, a diamond-like thin film alone cannot exhibit sufficient durability (corrosion resistance and abrasion resistance) and an interlayer should be present. As a result, it has been found that the relatively thick layer of 70 Å or more used for improving corrosion resistance increases internal stress, which reduces cohesiveness, and that a protective film having high durability cannot be attained without the interlayer, such as one containing Si. As shown here, no studies had been made based on the idea that a single diamond-like thin film having a thickness of less than 70 Å can exhibit high cohesion and durability.

Based on these findings, the present inventor found that a diamond-like protective film having a thickness of 40 Å or less even improved cohesion to the surface of the thin-film magnetic head, while exhibiting the same level of corrosion resistance and abrasion resistance as those of the conventional head. Accordingly, in the present invention, the interlayer can be omitted and the film thickness of 40 Å or less, or even 30 Å or less can be attained, thereby reducing the number of production steps, as well as reducing the distance between the head and the medium.

The present invention provides a magnetoresistive type thin-film magnetic head, wherein a diamond-like thin film as a protective film having the composition represented by the following formula: CHₐO_{b}N_{c}F_{d}BₑP_{f}

(where a=0-0.7, b=0-1, c=0-1, d=0-1, e=0-1 and f=0-1) is formed on at least the surface of the head contacting to a recording medium. With this structure, it becomes possible to attain an overall film thickness of 40 Å or less, or even 30 Å or less, which is much thinner than the conventional minimum thickness of 70 Å, while maintaining high corrosion resistance and abrasion resistance.

In the present invention, the single protective film made of an amorphous diamond-like carbon film in a predetermined composition ratio is formed on at least the surface of the thin-film magnetic head facing a recording medium, i.e. the floating surface or the sliding surface in contact with the medium. The protective film can be formed by applying a DC bias voltage or self-bias to a thin-film magnetic head, and by conducting vapor deposition methods such as plasma CVD method and ionization vapor deposition method.

Since the thus formed protective film can be made to have a thickness of approximately 40 Å or even 30 Å or less, the present invention has advantages in that the distance between the MR thin-film magnetic head and the medium can be reduced, which is suitable for high-density recording. In addition, even when the film is made to have such a small thickness, the thin-film magnetic head exhibits almost the same level of corrosion resistance and abrasion resistance as those of the head having the thick protective film of 70 Å or more disclosed in Japanese Patent Application Kokai No. 10-275308.

In the case of the conventional protective film having a Si-containing interlayer, penetration of corrosive gases such as moisture cannot be fully prevented for the reason mentioned above, and therefore, it is necessary to make the protective film thicker. On the other hand, the protective film of the present invention exhibits excellent cohesion to the surface to be protected, even though it is much thinner as compared with the conventional film. This may be the reason that the film of the present invention can prevent the corrosive gases from penetrating and corrosion resistance is improved.

### BRIEF DESCRIPTION OF THE DRAWINGS

[FIG. 1]

FIG. 1 shows a cross-section of the MR thin-film magnetic head of the present invention.

[FIG. 2]

FIG. 2 shows a perspective view of the magnetic disk device equipped with the magnetic head device using the MR thin-film magnetic head of the present invention

[FIG. 3]

FIG. 3 shows an enlarged perspective view of the slider portion of FIG. 2.

### PREFERRED EMBODIMENT OF THE INVENTION

The composition of the amorphous diamond-like thin film to be used for the protective film is represented by the following formula: CHₐO_{b}N_{c}F_{d}BₑP_{f}

where C is essential, and a=0-0.7, b=0-1, c=0-1, d=0-1, e=0-1 and f=0-1, in terms of atomic ratio.

The film formed by vapor deposition method such as plasma CVD method, ionization vapor deposition method and ECR plasma CVD method, in which hydrocarbon is used as material, generally contains H with a=0.05-0.7. However, it is possible to obtain the layer that does not contain hydrogen, by forming a diamond-like thin film by follow cathode method (FCVA), sputtering method and the like where carbon is used as a target.

Diamond-like carbon (DLC) film is sometimes referred to as “diamond carbon film,” “i-carbon film” and the like. With respect to the diamond-like carbon film, reference can be made to, for example, Japanese Patent Application Kokai Nos. 62-145646 and 62-145647, and New Diamond Forum, Vol. 4 No. 4 (issued in Oct. 25, 1988). As is described in the above-mentioned document (New Diamond Forum), Raman spectroscopic analysis showed that the DLC film has a broad peak of Raman scattering spectrum at 1400-1700 cm⁻¹, which is different from diamond having a narrow peak at 1333 cm⁻¹, and graphite having a narrow peak at 1581 cm⁻¹, which in turn suggests that the DLC film has distinctively different structure from graphite and diamond. The broad peak observed in Raman spectroscopic analysis spectrum of the DLC film is subject to change, due to the change in the elements included, other than carbon and hydrogen. The DLC film is an amorphous thin film mainly composed of carbon atoms and hydrogen atoms, in which carbon atoms are randomly bonded via sp2 and sp³ bonds.

In the present invention, the thickness of the DLC film is typically 10-40 Å, preferably 15-30 Å. When the film is thicker, the distance between the MR thin-film magnetic head and the recording medium becomes large, and therefore, such thickness is not preferred for the thin-film magnetic head used for high-density recording.

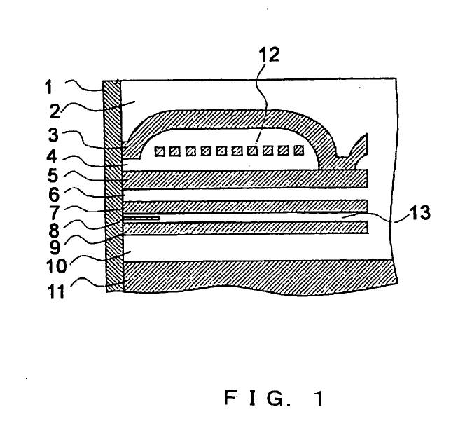

The thin-film magnetic head of the present invention will be explained below. FIG. 1 shows a schematic cross section of one embodiment of the thin-film magnetic head of the present invention. The thin-film magnetic head shown in the drawing has: a protective layer 1 made of a diamond-like thin film of the present invention; a protective layer 2; an upper magnetic pole layer 3; a gap 4; a lower magnetic pole layer 5; an insulation layer 6; an upper shield layer 7; an MR element 8; a lower shield layer 9; a base layer 10; a substrate 11; a conductive coil 12; and an insulation layer 13. The thin-film magnetic head illustrated in the figure is a so-called MR induction type combined head, having both an MR head portion for reproducing and an induction type head portion for recording. The induction type head portion for recording is composed of the upper magnetic pole layer 3, the lower magnetic pole layer 5, and the gap 4 and the conductive coil 12 sandwiched therebetween. The MR head portion is composed of the upper shield layer 7, the lower shield layer 9, and the insulation layer 13 and the MR element 8 sandwiched therebetween. In the Figure, the induction type head portion locates on the trailing side, and the MR head portion on the leading side. These compositions are known, and reference can be made to, for example, Japanese Patent Application Kokai No. 10-275308.

The thin-film magnetic head unit is formed by laminating these structures, and the protective film 1 of the present invention is formed on at least the surface of the unit on which the magnetic recording medium (magnetic disk) runs or with which the medium slides in contact, in other words, on the surface facing the recording medium (n the figure, on the left side of the drawing and on the plane perpendicular to the plane of the paper).

In FIG. 1, the MR induction type combined head is illustrated, and it should be noted that, more sensitive structures such as GMR (Giant Magnetoresistive) structure, TMR (Tunneling Junction Magnetoresistive) structure and CPP (Current Perpendicular Plane) structure can be used as well, instead of the MR element 8.

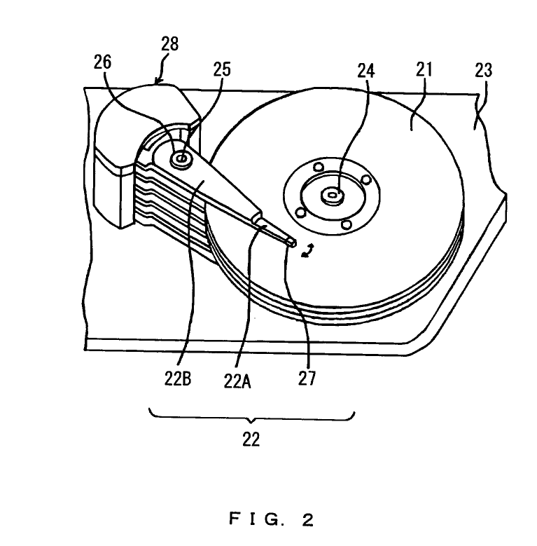

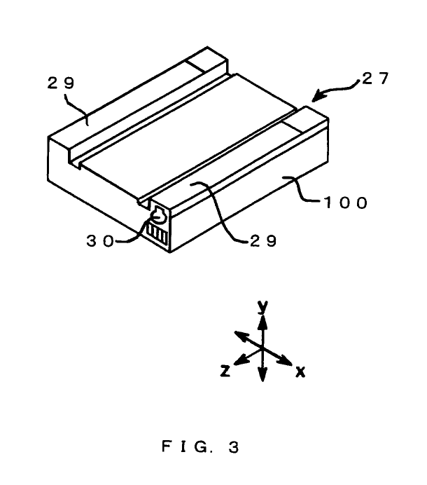

FIG. 2 shows an entire view of the magnetic disk device. A driving portion has plural magnetic head devices supported thereby, and each of the devices has a slider having a thin-film magnetic head, at the front end of the arm portion. FIG. 3 shows a perspective view of the slider having the thin-film magnetic head, and the slider has the MR head on the trailing side (air-outflow end) of the slider.

This embodiment illustrates one type of the magnetic disk device, called CSS (contact start-stop) action type. As shown in FIG. 2, this magnetic disk device has plural magnetic recording media 21, and plural magnetic head devices 22, each of which is associated with the respective magnetic recording medium 21. The magnetic recording medium 21 is rotated by the spindle motor 24 fixed to the body 23. The magnetic head device 22 is rotatably fixed to the fixing axis 25 fixed to the body 23 via the bearing 26. In this embodiment, plural magnetic head devices 22 are fixed to the fixing axis 25 via the same bearing 26, and with this structure, plural magnetic head devices 22 can be rotated together as one unit. The magnetic head device 22 has a magnetic head slider 27 at the tip thereof. The magnetic disk device also has a driving portion 28 at the other end of the magnetic head device 22, which is used for positioning the slider 27 on the track of the magnetic recording medium 21. The driving portion 28 is used for rotating the magnetic head device 22 with the fixing axis 25 as its rotating center, and with this structure, the slider 27 is movable in the radial direction relative to the magnetic recording medium 21.

FIG. 3 shows an enlarged perspective view of the slider shown in FIG. 2. The slider 27 is made of, for example, attic (Al₂O₃.TiC), and has a substrate 100 in the shape of almost hexahedron as a whole. Among the six surfaces, the surface facing the magnetic recording medium 21 is a recording medium-facing surface or an air bearing surface (ABS) 29. As shown in FIG. 3, on one side of the slider 27 that is perpendicular to the ABS 29, the thin-film magnetic head 30 is formed.

The following is the explanation of the recording-reproducing mechanism using the magnetic disk device having such a structure, with reference to FIG. 2. In the case of the CSS action type, when the magnetic disk device is not operated, i.e. when the spindle motor 24 is not operated and the magnetic recording medium 21 is not rotated, the ABS 29 of the slider 27 and the magnetic recording medium 21 are brought into contact. When recording or reproducing is performed, the magnetic recording medium 22 is rotated at a high speed by the spindle motor 24. This will generate airflow, and in turn generate aerodynamic lift. Utilizing this lift, the slider 27 is lifted up from the surface of the magnetic recording medium 21, and at the same time, the slider is shifted by the driving portion 28 in the horizontal direction relative to the magnetic recording medium 21. During this movement, recording or reproducing is performed by the thin-film magnetic head 30 formed on one surface of the slider 27.

Production of the Protective Film

A diamond-like carbon film (hereinbelow, simply referred to as “DLC film”) can be formed by, for example, plasma CVD method, ionization vapor deposition method, follow cathode method and ECR plasma CVD method, and in addition, sputtering method can be used.

With respect to the plasma CVD method used for forming the DLC film, reference can be made to, for example, Japanese Patent Application Kokai No. 4-41672. The plasma used in plasma CVD method may be either direct current or alternating current, but alternating current is preferred. Alternating current can range from a few hertz to microwave. In addition, ECR plasma described in, for example, “Diamond thin-film technique” (published by Technology Center) can be used. Moreover, a bias voltage can be applied.

When the DLC film is formed using plasma CVD method, the material gas is preferably selected from the following group of compounds.

Examples of the compounds containing C and H include hydrocarbons, such as methane, ethane, propane, butane, pentane, hexane, ethylene and propylene.

Examples of the compounds containing C+H+O include CH₃OH, C₂H₅OH, HCHO and CH₃COCH₃.

Examples of the compounds containing C+H+N include ammonium cyanide, hydrogen cyanide, monomethylamine, dimethylamine, allylamine, aniline, diethylamine, acetonitrile, azoisobutane, diallylamine, ethylamine, MMH, DMH, triallylamine, trimethylamine, triethylamine and triphenylamine.

In addition, the above-mentioned compounds can be used in combination, or used together with O sources, ON sources, N sources, H sources, F sources, B sources, P sources and the like.

It is also possible to use O₂, O₃ and the like (as O sources), CO, CO₂ and the like (as C+O sources), H₂ and the like (as H sources); H₂O and the like (as H+O sources), N₂ (as an N source), NH₃ and the like (as N+H sources), compounds of N and O represented by NOx, such as NO, NO₂ and N₂O (as N+O sources), (CN)₂ and the like (as N+C sources), NH₄ F and the like (as N+H+F sources), and O₂+F₂ and the like (as O+F sources).

The flow rate of the above-mentioned material gases can be selected depending on the type of the material gas. In general it is preferred that the operating pressure be 1-70 Pa and the input power be 10 W-5 kW.

In the present invention, ionization vapor deposition method can be also used for forming the DLC film. With respect to ionization vapor deposition method, reference can be made to, for example, Japanese Patent Application Kokai No. 59-174508. It should be noted that the methods and the devices are not limited to the disclosed ones, and other types of ionization vapor deposition technique can be applied, if it is possible to accelerate the material ionized gas of the protective film. In this case, as one example of the preferred device, rectilinear ion type or deflection ion type device described in Japanese PatentApplication Kokai No. 59-174508 can be mentioned.

In ionization vapor deposition method, the inside of the vacuum container is kept under the high-vacuum of approximately 10⁻⁴ Pa. This vacuum container is equipped with a flament therein which generates thermoelectrons when heated by the alternating-current power supply. This filament is sandwiched by an electrode couple, and voltage Vd is applied to the filament. In addition, an electromagnetic coil which generates a magnetic field for capturing ionized gas is placed in such manner that it surrounds the filament and the electrode couple. The material gas collides with the thermoelectrons from the filament, and generates positive thermolytic ions and electrons. This positive ion is accelerated by negative potential Va applied to the grid. By adjusting Vd, Va and the magnetic field of the coil, the composition and the quality of the film can be altered. In addition, a bias voltage can be applied.

When the DLC film is formed by ionization vapor deposition method, the same material gases as those of plasma CVD method can be used. The flow rate of the material gas can be selected depending on the type of the gas. In general, the operating pressure is preferably 1-70 Pa.

It is also possible to form the DLC film by sputtering method. In this case, gases such as O₂, N₂, NH₃, CH₄ and H₂ as reactive gas can be introduced, in addition to sputter gas, such as Ar and Kr. In addition, C may be used as a target, or mixed target containing C, N, O and the like or more than two targets may be used. Polymer can be used as a target. With the use of such targets, a radiofrequency power, an alternating-current power or a direct current power is applied, thereby sputtering the target; and the sputter is accumulated on the substrate, thereby forming DLC film. The radiofrequency sputter power is generally 50 W-2 kW. In general, the operating pressure is preferably 10⁻³-0.1 Pa.

With the used of such targets, the radiofrequency power is applied, thereby sputtering the target, and the sputter is accumulated on the predetermined surface of the thin-film magnetic head, thereby forming a protective film. In this case, a negative bias voltage is used for applying bias to the substrate or the thin-film magnetic head. The bias voltage is preferably direct current. Alternatively, self-bias can be applied instead of the bias voltage. The bias voltage is preferably between −10 and −2000 V, more preferably between −50 and −1000 V The radiofrequency sputter power is generally 50 W-2 kW. In general the operating pressure is preferably 0.0013-0.13 Pa.

Prior to the formation of the diamond-like protective film, it is desired that vapor-phase etching using gas such as Ar and Kr be conducted on the predetermined surface of the thin-film magnetic head in order to clean the surface. Due to the etching, fine asperity is formed on the surface of the thin-film magnetic head, which works as anchors and better cohesion can be obtained. For example, in the above-mentioned ionization vapor deposition method, Ar gas is introduced prior to the introduction of the gas for deposition, and then etching is conducted on the predetermined surface of the thin-film magnetic head.

### EXAMPLES

### Formation of the Protective Film

Formation of DLC

On the contacting surface of a thin-film magnetic head to a recording medium (Examples 1-3: etching with Ar; Example 4: no etching), a DLC1 film and a DLC2 film were formed by self-bias RF plasma CVD method, under the following conditions.

DLC1

Material gas: C₂H₄ (0.017 Pa·m³·s⁻¹)

Power source: RF

Operating pressure: 66.5 Pa

Input power: 500 W

Rate of film formation: 100 nm/min

Film composition: CH_{0.21}

Film thickness: 25 Å

DLC2

Material gas: C₂H₄ and N₂ (0.085 Pa·m³ s⁻¹)

Power source: RF

Operating pressure: 66.5 Pa

Input power: 500 W

Rate of film formation: 100 nm/min

Film composition: CH_{0.25}O_{0.03}N_{0.08}

Film thickness: 15 Å

The results are shown in Table 1.

### COMPARATIVE EXAMPLES

### Formation of the Protective Film

### Comparative Examples 1-2

For comparison, sputtering of Si was conducted at the lower layer on the running surface of the thin-film magnetic head, until the thickness of 15-25 Å was obtained.

On the layer, the above-mentioned DLC1 or DLC2 was formed in the combination and with the thickness shown in Table 1.

### Comparative Examples 3-5

Si(CH₃)₄ and C₂H₄ were introduced as known material gases for compounds containing Si, C and H, at the flow rates of 8 SCCM and 20 SCCM, respectively. RF of 500 W was applied as alternating current for generating plasma, and the operating pressure of 6.66 Pa and the self-bias of −400 V were applied on the running surface of the MR thin-film magnetic head, thereby forming films of 30, 50 and 70 Å, in Comparative Examples 3, 4 and 5, respectively.

The results are shown in Table 1. The values shown in the CSS column were the average numbers of defectives having reading failure (per 1000) after the start-stop action was repeated 100×10⁴ times, the average being calculated from 100 times of tests.

The corrosion resistance was obtained using accelerated test, and the values in the column were the average numbers of defectives having reading failure (per 1000) after immersing the samples for 48 hours into purified water heated to 80° C., the average being calculated from 100 times of tests.

TABLE 1

| | Lower layer | | Upper layer | | | | |
|---|---|---|---|---|---|---|---|
| | | Film | | Film | Total thickness | | Corrosion |
| | Compo- | thickness | Compo- | thickness | of protective film | CSS | resistance |
| | sition | (Å) | sition | (Å) | (Å) | Defective | Defective |
| Example 1 | | 0 | DLC1 | 25 | 25 | 3 | 4 |
| 2 | | 0 | DLC1 | 20 | 20 | 4 | 4 |
| 3 | | 0 | DLC2 | 10 | 10 | 5 | 6 |
| 4 | | 0 | DLC1 | 30 | 30 | 4 | 3 |
| Comparative | Si | 15 | DLC1 | 15 | 30 | 68 | 192 |
| Example 1 | sputter | | | | | | |
| 2 | Si | 25 | DLC2 | 25 | 50 | 9 | 113 |
| | sputter | | | | | | |
| 3 | | 0 | SiCH | 30 | 30 | 8 | 58 |
| 4 | | 0 | SiCH | 50 | 50 | 6 | 31 |
| 5 | | 0 | SiCH | 70 | 70 | 3 | 2 |

### EFFECT OF THE INVENTION

As is apparent from the results shown in Table 1, in the case of the Comparative Examples 1 and 2 in which the lower layer was formed by sputtering Si, the DLC thin film did not exhibit sufficient durability and corrosion resistance, even though the thickness of 25 Å was attained. The reason for this is believed that, as explained above, when Si is sputtered, fine masses are easily formed. The layer of SiC_{X}H_{Y}O_{z}N_{W} alone did not exhibit sufficient corrosion resistance when the thickness was 50 Å, and the thickness of 70 Å was required as described in the reference. When the thickness was 30 Å, durability and corrosion resistance were remarkably lowered.

On the other hand, in the Example of the present invention, the DLC film alone exhibited excellent durability and corrosion resistance. Even when the thickness is 40 Å or less, or even 30 Å or less, the film can be used as the protective film for the MR head. Since the distance between the head and the medium is remarkably Reduced, the film is suitable for a recording medium having high-packing density.

What I claim is:

1. A thin-film magnetic head having an MR head portion containing magnetoresistive elements, wherein a protective film having the composition represented by the following formula:
CHₐO_{b}N_{c}F_{d}BₑP_{f}
(where a=0-0.7, b=0-1, c=0-1, d=0-1, e=0-1 and f=0-1, in terms of atomic ratio), and having a thickness of 40 A or less, is formed on at least the surface of said MR head portion facing a recording medium.

2. The magnetic head according to claim 1, wherein the thickness of said protective film is 10-30 Å.

3. The magnetic head according to claim 1 or 2, wherein a=0.05-0.7.

4. A method for producing a thin-film magnetic head, wherein vapor deposition is conducted on at least the surface of said thin-film magnetic head facing a recording medium until a film having a thickness of 40 Å or less is formed, by using material gas that is adjusted so as to form a diamond-like protective film having the composition represented by the following formula:
CHₐO_{b}N_{c}F_{d}BₑP_{f}
(where a=0-0.7, b=0-1, c=0-1, d=0-1, e=0-1 and f=0-1).

5. The method according to claim 4, wherein vapor-phase etching is conducted prior to the formation of the diamond-like protective film on the surface of the thin-film magnetic head.

6. The method according to claim 4 or 5, wherein vapor deposition is conducted by applying a negative bias voltage to the thin-film magnetic head.

7. The method according to any one of claims 4 to 6, wherein the thickness of said protective film is 10-30 Å.

8. The method according to any one of claims 4 to 7, wherein a=0.05-0.7.

9. A magnetic disk device having at least one slider equipped with the thin-film magnetic head according to claim 1.
